(19) United States
(12) Patent Application Publication
(10) Pub. No.: US 2026/0307144 A1
(43) Pub. Date: Oct. 8, 2026

(54) IRON-BASED MIXED POWDER AND OXYGEN REACTANT

(71) Applicant: JFE STEEL CORPORATION, Chiyoda-ku, Tokyo (JP)

(72) Inventors: Naoki YAMAMOTO, Chiyoda-ku, Tokyo (JP); Kohsuke ASHIZUKA, Chiyoda-ku, Tokyo (JP); Shigeru UNAMI, Chiyoda-ku, Tokyo (JP)

(73) Assignee: JFE STEEL CORPORATION, Chiyoda-ku, Tokyo (JP)

(21) Appl. No.: 19/479,015

(22) PCT Filed: Jan. 18, 2024
(86) PCT No.: PCT/JP2024/001240

§ 371 Date: Oct. 27, 2025

(30) Foreign Application Priority Data
May 17, 2023 (JP) 2023-081836

(51) Int. Cl. B22F 1/12; B22F 1/05

(52) U.S. Cl. CPC B22F 1/12; B22F 1/05; B22F 2301/35; B22F 2302/45; B22F 2304/10

(57) ABSTRACT

Provided are an iron-based mixed powder and an oxygen reactant that are easily producible, have high reactivity with oxygen, and suppress hydrogen gas generation. An iron-based mixed powder consists of: an iron-based powder having an atomic ratio O/Fe of oxygen to iron of 0.800 or less; and a sulfur-containing powder having a sulfur content of 10.000 mass % or more and 100.000 mass % or less, wherein content of the sulfur-containing powder is 0.020 mass % or more and 5.000 mass % or less relative to total content of the iron-based powder and the sulfur-containing powder.

### TECHNICAL FIELD

The present disclosure relates to an iron-based mixed powder and an oxygen reactant.

### BACKGROUND

Oxygen reactants utilizing the reaction between iron-based powder and oxygen are used, for example, as deoxidizing agents or heat-generating agents. Deoxidizing agents, when sealed in containers together with preservation objects such as food or pharmaceutical products, can create a low-oxygen state within the containers, and thus are used to suppress quality degradation of preservation objects caused by oxidation, aerobic mold growth, and the like. Heat-generating agents are widely used as disposable body warmers, for example. As such oxygen reactants, iron-based powder to which water, active carbon, sodium chloride, etc. are added is used to further promote the reaction with oxygen. Moreover, in the oxygen reactants, additives may be added in order to not only adjust the reaction rate and thereby adjust the amount of heat generation but also treat by-product gases such as hydrogen.

Deoxidizing agents and heat-generating agents are often stored sealed in non-breathable packaging material immediately after production. However, if oxygen remains inside the packaging material, the oxidation of the iron progresses. With this oxidation, water added to the deoxidizing agent or heat-generating agent is decomposed and hydrogen gas is generated. If a large amount of hydrogen gas is generated, the packaging material may expand or even rupture. Hence, the generation of hydrogen gas needs to be suppressed.

Patent Literature (PTL) 1 discloses a body warmer. The body warmer uses iron powder treated with sulfur, as an oxidizable substance. Specifically, the oxidizable substance is produced by any of the following methods: heating sulfur powder and iron powder; heating iron powder that is coated with a sulfur solution by applying the sulfur solution to the iron powder or by immersing the iron powder in the sulfur solution and then drying it; and heating iron powder in a solution in which sulfur is dissolved in a solvent. PTL 1 discloses that the amount of gas generated is reduced by using iron powder treated with sulfur.

PTL 2 relates to raw material iron powder for slow heat-generating compositions and a method of producing the same. The raw material iron powder is mixed with a reaction aid, water, and a water retention agent to be used for compositions that slowly generate heat in air. The raw material iron powder is formed by mixing iron powder whose pH measured using a supernatant obtained by adding 1 g of the iron powder to 100 ml of water and stirring the mixture is 8 to 10 with thiosulfate powder so that the sulfur content will be 0.001% to 0.2% by weight. PTL 2 discloses that the use of the raw material iron powder can effectively suppress hydrogen gas generation during storage without adding a large amount of substances that adversely affect the heat generation properties of the slow heat-generating composition.

### CITATION LIST

### Patent Literature

PTL 1: JP S58-32762 A
PTL 2: JP H8-183951 A

### SUMMARY

### Technical Problem

However, the production process of the oxidizable substance disclosed in PTL 1 is complicated because the treatment using sulfur requires heating. There is also a demand to effectively utilize sulfur-containing powders other than the thiosulfate powder disclosed in PTL 2.

It could therefore be helpful to provide an iron-based mixed powder and an oxygen reactant that are easily producible, have high reactivity with oxygen, and suppress hydrogen gas generation.

### Solution to Problem

We thus provide the following iron-based mixed powder and oxygen reactant.

[1] An iron-based mixed powder consisting of: an iron-based powder having an atomic ratio O/Fe of oxygen to iron of 0.800 or less; and a sulfur-containing powder having a sulfur content of 10.000 mass % or more and 100.000 mass % or less, wherein content of the sulfur-containing powder is 0.020 mass % or more and 5.000 mass % or less relative to total content of the iron-based powder and the sulfur-containing powder.

[2] The iron-based mixed powder according to [1], wherein the sulfur-containing powder includes manganese sulfide powder.

[3] The iron-based mixed powder according to [1] or [2], wherein a median size on a volume basis of the iron-based mixed powder is 70 μm or more and 100 μm or less.

[4] An oxygen reactant comprising an iron-based mixed powder consisting of: an iron-based powder having an atomic ratio O/Fe of oxygen to iron of 0.800 or less; and a sulfur-containing powder having a sulfur content of 10.000 mass % or more and 100.000 mass % or less, wherein content of the sulfur-containing powder is 0.020 mass % or more and 5.000 mass % or less relative to total content of the iron-based powder and the sulfur-containing powder.

[5] The oxygen reactant according to [4], wherein the sulfur-containing powder includes manganese sulfide powder.

[6] The oxygen reactant according to [4] or [5], wherein a median size on a volume basis of the iron-based mixed powder is 70 μm or more and 100 μm or less.

### Advantageous Effect

It is thus possible to provide an iron-based mixed powder and an oxygen reactant that are easily producible, have high reactivity with oxygen, and suppress hydrogen gas generation.

### DETAILED DESCRIPTION

An iron-based mixed powder and an oxygen reactant according to an embodiment of the present disclosure will be described. Hereinafter, the term “iron-based powder” refers to a powder containing 50.000 mass % or more of Fe. The term “iron-based alloy powder” refers to an alloy powder containing 50.000 mass % or more of Fe. The term “iron powder” refers to a powder consisting of Fe and inevitable impurities, which is commonly called “pure iron powder” in the present technical field.

The iron-based mixed powder according to this embodiment is a mixed powder consisting of: an iron-based powder having an atomic ratio O/Fe of oxygen to iron of 0.800 or less; and a sulfur-containing powder having a sulfur content of 10.000 mass % or more and 100.000 mass % or less. The content of the sulfur-containing powder in the iron-based mixed powder according to this embodiment is 0.020 mass % or more and 5.000 mass % or less relative to the total content of the iron-based powder and the sulfur-containing powder.

The oxygen reactant according to this embodiment comprises the foregoing iron-based mixed powder.

The iron-based mixed powder according to this embodiment has high reactivity with oxygen and can suppress hydrogen gas generation, and therefore is suitable for use as an oxygen reactant.

The iron-based mixed powder and the oxygen reactant according to this embodiment will be described in detail below.

The iron-based mixed powder according to this embodiment is a powder obtained by mixing iron-based powder and sulfur-containing powder. The iron-based mixed powder consists of the iron-based powder and the sulfur-containing powder.

Examples of the iron-based powder include iron powder and iron-based alloy powder. In the case where the iron-based powder is iron-based alloy powder, the iron-based powder may contain, in addition to Fe, elements such as C, S, O, N, Si, Na, Mg, and Ca. In the case where the iron-based powder is iron powder, the iron-based powder may contain elements such as C, S, O, N, Si, Na, Mg, and Ca as inevitable impurities.

Iron, when oxidized, decreases in reactivity with oxygen. Accordingly, it is preferable to use iron-based powder that is as unoxidized as possible. Specifically, to ensure a sufficient reaction amount with oxygen, the atomic ratio of oxygen to iron (hereinafter also referred to as “O/Fe”) in the iron-based powder is 0.800 or less, preferably 0.700 or less, more preferably 0.600 or less, and further preferably 0.250 or less. No lower limit is placed on O/Fe. O/Fe may be 0, and may be 0.000. In consideration of industrial productivity, however, O/Fe is preferably 0.030 or more and more preferably 0.150 or more.

The O/Fe of the iron-based powder is measured by X-ray diffraction, specifically, by the method described in the EXAMPLES section.

The method of producing the iron-based powder is not particularly limited, and the iron-based powder may be produced by conventional methods. For example, the iron-based powder may be produced by a method such as atomization or reduction. Atomization is a method in which molten metal is sprayed with water or gas to turn into powder and is cooled to solidify. Water atomization or gas atomization may be used. Reduction is a method in which, for example, iron ore powder or iron oxide (mill scale) generated from the surface of a steel sheet during hot rolling of steel material is reduced. Thus, the iron-based powder may be atomized iron-based powder or reduced iron-based powder. The iron-based powder may be water-atomized iron-based powder or gas-atomized iron-based powder.

The above-described powder may be further subjected to one or both of grinding and classification to adjust particle size. The methods of grinding and classification are not particularly limited and may be conventional methods.

To remove oxygen from the above-described powder to cause the O/Fe of the iron-based powder to be 0.800 or less, a heat treatment (deoxidation treatment) may be performed using a reducing agent under conditions where the maximum temperature is 750° C. or higher. As the reducing agent, a carbon material such as coke, coal, or graphite, or hydrogen gas may be used. For example, the reducing agent may be added to or mixed with the above-described powder.

The sulfur-containing powder in this embodiment is preferably a powder containing one or both of elemental sulfur and sulfur compound(s). The sulfur-containing powder may consist of elemental sulfur, or consist of sulfur compound(s). In other words, the sulfur-containing powder preferably includes one or both of powder of elemental sulfur and powder of sulfur compound(s), and may be powder of elemental sulfur and may be powder of sulfur compound(s). The sulfur contained in the sulfur-containing powder may be derived solely from one or both of elemental sulfur and sulfur compound(s). In the following description, the term “sulfur powder” refers to powder of elemental sulfur.

Examples of the sulfur compound include sulfides. Examples of the sulfides include manganese sulfide, calcium sulfide, sodium sulfide, and nickel sulfide. In other words, the sulfur-containing powder may include any of manganese sulfide powder, calcium sulfide powder, sodium sulfide powder, and nickel sulfide powder, and may be any of manganese sulfide powder, calcium sulfide powder, sodium sulfide powder, and nickel sulfide powder. For example, in the case where a deliquescent sulfur compound such as thiosulfate is used, it may absorb moisture in air and, after mixing, supply water to surrounding iron particles, thereby causing rust formation on the iron-based powder before use. From the viewpoint of preventing property deterioration due to rust formation, the sulfur-containing powder preferably contains one or both of sulfide and elemental sulfur, and more preferably is one or both of sulfide powder and sulfur powder. Among the sulfides, manganese sulfide powder has a specific gravity that is higher than sulfur powder and close to iron-based powder, and is therefore more miscible with iron-based powder. Moreover, manganese sulfide has lower flammability than calcium sulfide and thus has better storability. Accordingly, the sulfur-containing powder preferably contains manganese sulfide, and more preferably is manganese sulfide powder.

The sulfur-containing powder may also contain, for example, additives. The additives may or may not include sulfur. Examples of the additives include silica and carbon. In other words, the sulfur-containing powder may contain silica powder, and may contain carbonaceous powder. Silica powder is an inert powder that does not contribute to the reaction between iron and oxygen, and may be added to enable more uniform mixing of elemental sulfur and sulfur compound with the iron-based powder. Carbonaceous powder may be added to further promote the reaction between iron and oxygen. Examples of the carbonaceous powder include active carbon powder, coke powder, carbon black powder, acetylene black powder, and graphite powder.

The sulfur-containing powder has a sulfur content of 10.000 mass % or more and 100.000 mass % or less. If the sulfur content in the sulfur-containing powder is 10.000 mass % or more, the proportion of sulfur that comes into contact with the surface of the iron-based powder increases, thereby improving the reactivity between iron and oxygen. Moreover, hydrogen gas generation can be suppressed. Therefore, the sulfur content in the sulfur-containing powder is 10.000 mass % or more, preferably 43.000 mass % or more, and more preferably 80.000 mass % or more. There is no particular upper limit on the sulfur content in the sulfur-containing powder, which may be as high as 100.000 mass %. From the viewpoint of adding additives, however, the sulfur content in the sulfur-containing powder may be 99.900 mass % or less, for example.

In the iron-based mixed powder according to this embodiment, the content of the sulfur-containing powder is 0.020 mass % or more and 5.000 mass % or less relative to the total content of the iron-based powder and the sulfur-containing powder. In the following description, the content of the sulfur-containing powder relative to the total content of the iron-based powder and the sulfur-containing powder is also simply referred to as the “content of the sulfur-containing powder.”

If the content of the sulfur-containing powder is 0.050 mass % or more, the reactivity with oxygen is improved and the effect of suppressing hydrogen gas is obtained. Therefore, the content of the sulfur-containing powder is 0.050 mass % or more, preferably 0.200 mass % or more, more preferably 0.600 mass % or more, and further preferably 1.100 mass % or more.

If the content of the sulfur-containing powder is 5.000 mass % or less, water on the surface of the iron-based powder is prevented from being acidified excessively, thereby suppressing hydrogen gas generation. While part of hydrogen gas is converted into hydrogen sulfide gas as a result of reaction with sulfur, excessive generation of hydrogen sulfide gas due to this reaction is suppressed, with it being possible to suppress the generation of rotten egg smell derived from hydrogen sulfide gas. Therefore, the content of the sulfur-containing powder is 5.000 mass % or less, and preferably 3.000 mass % or less.

It is preferable that the iron-based powder and the sulfur-containing powder are uniformly mixed in the iron-based mixed powder according to this embodiment. For example, a powder mixing device such as a V-shaped mixer, double cone mixer, or conical blender may be used to mix the iron-based powder and the sulfur-containing powder in the production of the iron-based mixed powder.

The median size on a volume basis of the iron-based mixed powder (i.e. the median particle size calculated from the particle size distribution on a volume basis, denoted by D₅₀) is not particularly limited as long as there is no problem in handling. From the viewpoint of further improving the reactivity with oxygen, however, the median size on a volume basis of the iron-based mixed powder is preferably 1000 μm or less, more preferably 400 μm or less, further preferably 200 μm or less, and particularly preferably 100 μm or less. From the viewpoint of ease of handling and reactivity with oxygen, the median size on a volume basis of the iron-based mixed powder is preferably 5 μm or more and more preferably 70 μm or more.

For the median size on a volume basis of the iron-based mixed powder, a value measured by a laser diffraction particle size distribution measuring device is used.

Specifically, the median size on a volume basis of the iron-based mixed powder is measured as follows. First, the powder to be measured is introduced into ethanol and dispersed by ultrasonic oscillation for 30 seconds or more. Following this, the particle size distribution on a volume basis is measured with a laser diffraction particle size distribution measuring device (LA-950V2 produced by HORIBA, Ltd.) using the laser diffraction/scattering method. The cumulative particle size distribution is calculated from the measured particle size distribution on a volume basis, and the median size is determined.

The oxygen reactant according to this embodiment comprises the iron-based mixed powder according to this embodiment. The oxygen reactant according to this embodiment is any oxygen reactant using the iron-based mixed powder, and may further comprise other components in addition to the iron-based mixed powder.

Examples of the other components include active carbon and saline solution.

As an example, the reaction mechanism in the case where saline solution is added to the iron-based mixed powder will be described. When the iron-based powder is mixed with a sulfur compound and saline solution is added to the mixture, the sulfur compound dissolves and as a result fine sulfur powder is generated at the boundary between the particles of iron contained in the iron-based powder and the particles of the sulfur compound. Then, the iron dissolves at the boundary due to the coexistence with chloride ions derived from the saline solution.

At the pores on the surface of the iron particles caused by the foregoing dissolution, hydrolysis of iron ions occurs, leading to a decrease in pH and potential of the aqueous solution. As a result, pitting corrosion proceeds, which further accelerates the dissolution of iron at the pores.

Furthermore, the sulfur in the fine sulfur powder generated on the surface of the iron particles reacts with the hydrogen generated during the hydrolysis to form hydrogen sulfide. Thus, hydrogen gas generation is considered to be suppressed in the system as a whole.

In addition, since hydrogen sulfide is more soluble in water than hydrogen, the hydrogen sulfide converted from the hydrogen generated during the hydrolysis is dissolved in water. Thus, hydrogen sulfide gas generation is considered to be suppressed.

It is expected that the same reaction mechanism as that in the above case using the sulfur compound also occurs when the iron-based powder is mixed with elemental sulfur.

The oxygen reactant according to this embodiment may be enclosed in a bag. Examples of the bag include a breathable packaging bag made by laminating nonwoven fabric and open pore polyethylene and a breathable packaging bag made by laminating paper and open pore polyethylene.

### Examples

The iron-based mixed powder according to this embodiment will be described below based on examples.

Iron-based mixed powders according to examples were each produced by the following procedure.

Iron ore powder was reduced using coke at 800° C. to 1000° C. to adjust O/Fe and obtain iron powder. O/Fe was calculated by measuring the contents of elemental Fe, Fe—O compounds, and other compounds using an X-ray diffractometer (SmartLab produced by Rigaku Corporation).

In Comparative Examples 2 to 15 and Examples 1 to 6, a powder obtained by mixing sulfur powder (SSE02PB produced by Kojundo Chemical Laboratory Co., Ltd.) with silica powder (SIO09PB produced by Kojundo Chemical Laboratory Co., Ltd.) and adjusting sulfur content was used as sulfur-containing powder. In Comparative Examples 16 to 21 and Examples 7 to 8, manganese sulfide powder (MNI09PB produced by Kojundo Chemical Laboratory Co., Ltd.) was used as sulfur-containing powder. In Comparative Examples 22 to 27 and Examples 9 to 10, calcium sulfide powder (CAI05PB produced by Kojundo Chemical Laboratory Co., Ltd.) was used as sulfur-containing powder.

The iron powder and the sulfur-containing powder were mixed to obtain the iron-based mixed powder according to each of the examples and comparative examples. In Comparative Example 1, no sulfur-containing powder was added. Table 1 shows the O/Fe of the iron powder, the type of the sulfur-containing powder, the sulfur content in the sulfur-containing powder (mass %), the content of the sulfur-containing powder (mass %), and the median size (D₅₀) of the iron-based mixed powder measured by the above-described method. In Table 1, the underlined values are outside the scope of this embodiment.

TABLE 1

| | Iron-based mixed powder | | | | | | | |
|---|---|---|---|---|---|---|---|---|
| | | Sulfur-containing | | Content | | Evaluation | | |
| | Iron-based | powder | | of sulfur- | | Oxygen | | Hydrogen |
| | powder | | Sulfur | containing | | reaction | Hydrogen gas | sulfide gas |
| | O/Fe | | content | powder | D₅₀ | amount | concentration | concentration |
| No. | (—) | Type | (mass %) | (mass %) | (μm) | (mL/g) | (vol %) | (ppm) |
| Comparative Example 1 | 0.150 | — | — | — | 420 | 50 | 12.3 | 0.0 |
| Comparative Example 2 | 0.820 | Mixture | 9.852 | 0.016 | 412 | 53 | 11.9 | 0.0 |
| Comparative Example 3 | 0.880 | of | 9.924 | 5.082 | 475 | 56 | 4.7 | 0.3 |
| Comparative Example 4 | 0.830 | sulfur | 8.451 | 0.021 | 495 | 62 | 11.2 | 0.0 |
| Comparative Example 5 | 0.920 | powder | 9.211 | 4.988 | 427 | 64 | 1.8 | 0.2 |
| Comparative Example 6 | 0.980 | and | 10.128 | 0.012 | 935 | 67 | 10.2 | 0.0 |
| Comparative Example 7 | 0.830 | silica | 10.043 | 5.118 | 720 | 69 | 4.5 | 0.3 |
| Comparative Example 8 | 0.860 | powder | 10.655 | 0.022 | 447 | 72 | 9.5 | 0.0 |
| Comparative Example 9 | 0.820 | | 10.552 | 4.885 | 413 | 75 | 1.6 | 0.2 |
| Comparative Example 10 | 0.050 | | 9.725 | 0.008 | 955 | 66 | 8.5 | 0.0 |
| Comparative Example 11 | 0.120 | | 9.559 | 5.343 | 780 | 69 | 2.5 | 0.3 |
| Comparative Example 12 | 0.780 | | 9.324 | 0.032 | 500 | 79 | 8.8 | 0.1 |
| Comparative Example 13 | 0.550 | | 9.749 | 4.789 | 478 | 83 | 1.8 | 0.2 |
| Comparative Example 14 | 0.230 | | 10.956 | 0.018 | 465 | 89 | 3.2 | 0.0 |
| Comparative Example 15 | 0.110 | | 12.535 | 5.043 | 420 | 92 | 2.3 | 0.3 |
| Example 1 | 0.750 | | 13.536 | 0.028 | 415 | 108 | 1.9 | 0.1 |
| Example 2 | 0.520 | | 11.542 | 4.752 | 407 | 104 | 1.8 | 0.2 |
| Example 3 | 0.230 | | 90.850 | 0.035 | 382 | 115 | 1.4 | 0.0 |
| Example 4 | 0.110 | | 99.842 | 0.025 | 212 | 118 | 1.2 | 0.0 |
| Example 5 | 0.221 | | 85.582 | 0.053 | 78 | 130 | 0.7 | 0.0 |
| Example 6 | 0.139 | | 88.254 | 0.045 | 92 | 128 | 0.5 | 0.0 |
| Comparative Example 16 | 0.815 | Manganese | 36.885 | 0.015 | 75 | 85 | 5.2 | 0.0 |
| Comparative Example 17 | 0.807 | sulfide | | 5.232 | 80 | 88 | 3.0 | 0.3 |
| Comparative Example 18 | 0.852 | powder | | 0.026 | 82 | 92 | 4.5 | 0.0 |
| Comparative Example 19 | 0.833 | | | 4.779 | 125 | 91 | 2.2 | 0.2 |
| Comparative Example 20 | 0.351 | | | 0.002 | 92 | 82 | 5.2 | 0.0 |
| Comparative Example 21 | 0.059 | | | 5.144 | 95 | 93 | 2.8 | 0.3 |
| Example 7 | 0.122 | | | 0.029 | 80 | 125 | 0.8 | 0.0 |
| Example 8 | 0.083 | | | 4.984 | 75 | 132 | 0.6 | 0.2 |
| Comparative Example 22 | 0.801 | Calcium | 44.446 | 0.017 | 88 | 87 | 4.5 | 0.0 |
| Comparative Example 23 | 0.813 | sulfide | | 5.086 | 98 | 86 | 4.8 | 0.3 |
| Comparative Example 24 | 0.835 | powder | | 0.028 | 95 | 93 | 2.8 | 0.0 |
| Comparative Example 25 | 0.821 | | | 4.965 | 90 | 90 | 3.0 | 0.2 |
| Comparative Example 26 | 0.246 | | | 0.018 | 86 | 92 | 3.5 | 0.0 |
| Comparative Example 27 | 0.050 | | | 5.068 | 90 | 94 | 3.3 | 0.3 |
| Example 9 | 0.108 | | | 0.023 | 85 | 151 | 0.2 | 0.0 |
| Example 10 | 0.085 | | | 4.921 | 90 | 165 | 0.1 | 0.2 |

For each of the iron-based mixed powders of the examples and comparative examples, the reactivity with oxygen, the amount of hydrogen gas generated, and the amount of hydrogen sulfide gas generated were evaluated as follows.

The reactivity with oxygen was evaluated as follows. First, 0.006 g of sodium chloride powder (NAH07PB produced by Kojundo Chemical Laboratory Co., Ltd.) and 1.50 g of the iron-based mixed powder were mixed. A mixture of 0.95 g of Isolite CG (No. 1 produced by Isolite Insulating Products Co., Ltd.), made of calcined diatomaceous earth, and 0.85 g of water was added to the obtained powder. The resulting material was loaded into a breathable packaging bag (45 mm×40 mm) to prepare an evaluation sample for the example or comparative example. The breathable packaging bag was made of a laminated material composed of nonwoven fabric and porous polyethylene. Each sample was then sealed in a gas barrier bag made of a five-layer

laminated material of nylon/polyethylene/aluminum foil/polyethylene/polyethylene, together with 3000 mL of air. The bags with the samples sealed therein were each left to stand at 25° C. for 72 hours. After this, the oxygen concentration of the gas inside the bag was measured using a gas chromatograph (GC3210D produced by GL Sciences Inc.). The measured oxygen concentration in the bag was subtracted from the oxygen concentration in air to determine the decrease of oxygen in the bag. Based on the decrease, the oxygen reaction amount (mL/g) per 1 g of the iron-based mixed powder was calculated.

The “oxygen reaction amount” in this example refers to the volume (mL) of oxygen that can be removed from 3000 mL of air at 25° C. and atmospheric pressure by 1 g of iron-based mixed powder over 72 hours. A higher oxygen reaction amount indicates higher reactivity with oxygen. Such iron-based mixed powder, when used in an oxygen reactant, is superior in terms of the total amount of heat generation, heat generation temperature, and heat generation time (i.e. has superior heat generation properties).

The amount of hydrogen gas generated and the amount of hydrogen sulfide gas generated were evaluated as follows. First, 0.06 g of sodium chloride powder (NAH07PB produced by Kojundo Chemical Laboratory Co., Ltd.) and 15.00 g of the iron-based mixed powder were mixed. A mixture of 7.89 g of Isolite CG (No. 1 produced by Isolite Insulating Products Co., Ltd.), made of calcined diatomaceous earth, and 7.11 g of water was added to the obtained powder. The resulting material was loaded into a breathable packaging bag (80 mm×80 mm) to prepare an evaluation sample for the example or comparative example. The breathable packaging bag was made of a laminated material composed of nonwoven fabric and porous polyethylene.

Each sample was then sealed in a gas barrier bag made of a five-layer laminated material of nylon/polyethylene/aluminum foil/polyethylene/polyethylene, together with 25 mL of air. The bags with the samples sealed therein were each left to stand at 55° C. for 72 hours. After this, the hydrogen gas concentration (vol %) inside the bag was measured using a gas chromatograph (GC3210D produced by GL Sciences Inc.). Further, the hydrogen sulfide concentration (ppm) inside the bag was measured using a gas monitor (GX-3R Pro produced by Riken Keiki Co., Ltd.).

A lower measured hydrogen gas concentration indicates less hydrogen gas generation.

If the measured hydrogen sulfide concentration was less than 0.3 ppm, which is the publicly known threshold under which humans do not perceive rotten egg smell, it was evaluated that hydrogen sulfide generation was prevented.

Table 1 also shows the evaluation results concerning the above-described oxygen reaction amount, hydrogen gas concentration, and hydrogen sulfide concentration.

The iron-based mixed powders of the examples exhibited higher reactivity with oxygen, smaller amount of hydrogen gas generated, and smaller amount of hydrogen sulfide generated than the powders of the comparative examples.

In Examples 3 to 10, the median size of the iron-based mixed powder was 400 μm or less. As a result, the reactivity with oxygen was further enhanced, and the amount of hydrogen gas generated was further reduced. In addition, hydrogen sulfide generation was prevented.

In Examples 5 to 10, the median size of the iron-based mixed powder was 200 μm or less. As a result, the reactivity with oxygen was higher and the amount of hydrogen gas generated was smaller than in Examples 1 to 4. In addition, hydrogen sulfide generation was prevented.

It was confirmed that the foregoing effects were obtained regardless of whether the sulfur-containing powder used was a mixture of sulfur powder and silica powder, manganese sulfide powder, or calcium sulfide powder.

Thus, the iron-based mixed powder according to this example has high reactivity with oxygen and suppresses hydrogen gas generation. The iron-based mixed powder according to this example also generates little hydrogen sulfide, thereby preventing rotten egg smell.

The embodiments disclosed in this specification are illustrative, and the present disclosure is not limited to such embodiments and modifications can be made as appropriate without departing from the object of the present disclosure.

### INDUSTRIAL APPLICABILITY

The present disclosure can be applied to iron-based mixed powders and oxygen reactants.

1. An iron-based mixed powder consisting of:
an iron-based powder having an atomic ratio O/Fe of oxygen to iron of 0.800 or less; and
a sulfur-containing powder having a sulfur content of 10.000 mass % or more and 100.000 mass % or less,
wherein content of the sulfur-containing powder is 0.020 mass % or more and 5.000 mass % or less relative to total content of the iron-based powder and the sulfur-containing powder.

2. The iron-based mixed powder according to claim 1, wherein the sulfur-containing powder includes manganese sulfide powder.

3. The iron-based mixed powder according to claim 1, wherein a median size on a volume basis of the iron-based mixed powder is 70 μm or more and 100 μm or less.

4. An oxygen reactant comprising
an iron-based mixed powder consisting of: an iron-based powder having an atomic ratio O/Fe of oxygen to iron of 0.800 or less; and a sulfur-containing powder having a sulfur content of 10.000 mass % or more and 100.000 mass % or less,
wherein content of the sulfur-containing powder is 0.020 mass % or more and 5.000 mass % or less relative to total content of the iron-based powder and the sulfur-containing powder.

5. The oxygen reactant according to claim 4, wherein the sulfur-containing powder includes manganese sulfide powder.

6. The oxygen reactant according to claim 4, wherein a median size on a volume basis of the iron-based mixed powder is 70 μm or more and 100 μm or less.

7. The iron-based mixed powder according to claim 2, wherein a median size on a volume basis of the iron-based mixed powder is 70 μm or more and 100 μm or less.

8. The oxygen reactant according to claim 5, wherein a median size on a volume basis of the iron-based mixed powder is 70 μm or more and 100 μm or less.
